(19) United States
(12) Patent Application Publication
(10) Pub. No.: US 2023/0359654 A1
(43) Pub. Date: Nov. 9, 2023

(54) IMPROVED OPERATION OF A QUESTION-AND-ANSWER SERVICE PROVIDED TO A TELECOMMUNICATIONS TERMINAL VIA A TELECOMMUNICATIONS NETWORK

(71) Applicant: Deutsche Telekom AG, Bonn (DE)

(72) Inventor: Katja JOHANNHOERSTER, Darmstadt (DE)

(21) Appl. No.: 18/000,302

(22) PCT Filed: Jun. 9, 2021
(86) PCT No.: PCT/EP2021/065456

§ 371 Date: Nov. 30, 2022

(30) Foreign Application Priority Data
Jun. 15, 2020 (EP) 20179989.7

(51) Int. Cl. G06F 16/332

(52) U.S. Cl. CPC G06F 16/3329

(57) ABSTRACT

A method for operation of a question-and-answer service provided to a telecommunications terminal via a telecommunications network includes: question information to be handled is fed to a reading comprehension processing chain and to a search processing chain; at least one item of paragraph information is generated by or in the search processing chain and is fed to the reading comprehension processing chain; a first artificial intelligence module produces first answer candidate information based on the reading comprehension processing chain and the at least one item of paragraph information, and a second artificial intelligence module produces second answer candidate information based on the search processing chain; and via or in a validation confidence processing chain, an evaluation and/or decision is made regarding answer information to be given.

### CROSS-REFERENCE TO PRIOR APPLICATIONS

This application is a U.S. National Phase application under 35 U.S.C. § 371 of International Application No. PCT/EP2021/065456, filed on Jun. 9, 2021, and claims benefit to European Patent Application No. EP 20179989.7, filed on Jun. 15, 2020. The International Application was published in German on Dec. 23, 2021 as WO 2021/254843 A1 under PCT Article 21(2).

### FIELD

The invention relates to a method for assisting the improved operation of a question-and-answer service provided to a telecommunications terminal via a telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal.

The invention furthermore relates to a system for assisting the improved operation of a question-and-answer service provided to a telecommunications terminal via a telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal.

The invention furthermore relates to a telecommunications network for assisting the improved operation of a question-and-answer service provided to a telecommunications terminal connected to a telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal.

Furthermore, the invention relates to a question-and-answer service or a question-and-answer service system for provision to a telecommunications terminal via a telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal.

Furthermore, the invention relates to a computer program comprising commands via which the steps of a method according to the invention can be carried out, and to a computer-readable medium provided for storing a computer program, or to a data carrier signal provided for transmitting a computer program, wherein the computer-readable medium or the data carrier signal stores or transmits a computer program according to the invention.

### BACKGROUND

Answering, in particular in a trustworthy and in-depth manner, natural language questions in an automated manner and without mandatory human interaction poses a challenge in many technical fields and areas of application.

### SUMMARY

In an exemplary embodiment, the present invention provides a method for operation of a question-and-answer service provided to a telecommunications terminal via a telecommunications network, wherein the question-and-answer service comprises, uses, or has access to an artificial intelligence system, wherein question information is fed to the artificial intelligence system as an input variable and the artificial intelligence system generates answer information as an output variable and/or provides the answer information to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain, and wherein the second artificial intelligence module is a part or a target of a search processing chain. The method comprises: in a first step, question information to be handled is fed to the reading comprehension processing chain and to the search processing chain; in a second step following the first step, at least one item of paragraph information is generated by or in the search processing chain and is fed to the reading comprehension processing chain; in a third step following the second step, the first artificial intelligence module produces first answer candidate information based on the reading comprehension processing chain and the at least one item of paragraph information, and the second artificial intelligence module produces second answer candidate information based on the search processing chain, wherein the first answer candidate information comprises first score information, and wherein the second answer candidate information comprises second score information; and in a fourth step following the third step, via or in a validation confidence processing chain, an evaluation and/or decision is made as to whether any of the following is selected or to be selected as answer information to be given: the first answer candidate information or a part thereof; or the second answer candidate information or a part thereof; or neither of the two.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a telecommunications network for assisting the improved operation of a question-and-answer service provided to a telecommunications terminal.

FIG. 2 schematically shows an artificial intelligence system according to the invention for a question-and-answer service of a telecommunications network according to the invention.

FIG. 3 schematically shows a question-and-answer service according to the invention with an artificial intelligence system and an additional artificial intelligence system.

### DETAILED DESCRIPTION

Exemplary embodiments of the invention provide an optimized method for assisting the improved operation of a question-and-answer service provided to a telecommunications terminal via a telecommunications network, wherein the method makes it possible in a comparatively easier and more efficient manner for the question-and-answer service to use an artificial intelligence system, wherein question information is fed to the artificial intelligence system as an input variable and the artificial intelligence system generates answer information as an output variable and/or provides this information, in particular to the telecommunications terminal.

In an exemplary embodiment, the invention provides a method for assisting the improved operation of a question-and-answer service provided to a telecommunications terminal via a telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain, and wherein the second artificial intelligence module is a part or a target of a search processing chain,
wherein the method comprises the following steps in relation to question information to be handled and in order to generate answer information to be given:
   in a first step, the question information to be handled is fed to the reading comprehension processing chain and to the search processing chain,
   in a second step following the first step, at least one item of paragraph information is generated by or in the search processing chain and is fed to the reading comprehension processing chain,
   in a third step following the second step,
      the first artificial intelligence module produces first answer candidate information based on the reading comprehension processing chain and the at least one item of paragraph information, and
      the second artificial intelligence module produces second answer candidate information based on the search processing chain, wherein the first answer candidate information comprises first score information, and wherein the second answer candidate information comprises second score information,
   in a fourth step following the third step, via or in a validation confidence processing chain, an evaluation and/or decision is made as to whether any of the following is selected or to be selected as answer information to be given
      the first answer candidate information or a part thereof or
      the second answer candidate information or a part thereof or
      neither of the two.

According to the present invention, it is thereby advantageously possible for a higher degree or a comparatively high degree of trustworthy and in-depth information to be incorporated in the answering, in an automated manner and without human interaction, of natural language questions, in particular in a technical context.

The possibility of being able to ask natural language questions in an automated manner and without mandatory human interaction and to obtain correct (in the sense of relevant information having a high truth value) and, in particular, meaningful answers is useful in many technical fields.

Such possible application scenarios include, for example, scenarios such as the provision of a repair manual or repair instructions for a technical device to a person with comparatively little practice in the use of the technical device or a person who has comparatively little practice or experience in the repair of the technical device. Further applications include the provision of an answer to a natural language question in the field of information on the production of a technical device or for the repair or production of a system in a wide variety of areas of application, for example in the field of energy saving or in the field of implementing technical protection against the effects of a climate change or the like. A large number of other areas of application of systems and methods for answering natural language questions which are geared toward the application or use of answers to natural language question are also conceivable and are addressed within the scope of the present invention.

According to the invention, question information is fed to the artificial intelligence system as an input variable and the artificial intelligence system generates answer information as an output variable or provides this answer information, in particular to the telecommunications terminal.

According to the invention, the artificial intelligence system is implemented as an open domain artificial intelligence system. Since the answering of natural language questions strongly depends on a good search corpus, i.e., a large number of documents that contain the answers to possible questions, it is provided according to the invention to use a thematically open search corpus. In addition, the existence of, if possible, a significant degree of redundancy of information in such a thematically open search corpus or such an open domain artificial intelligence system also plays a role. As a result, it is also advantageously possible according to the invention for possible correct answers to be differentiated from false-positive answers. An open domain question answering system, i.e., based on a (thematically) open domain, is aimed at an answer to the user's question, for example in the form of a comparatively short text, and in any case not in the form of a list of hits or of relevant documents. A natural language question, i.e., question information, is used as an input or as an input variable and answer information is generated as an output variable or provided, in particular to the relevant telecommunications terminal, via which the question information was generated or via which the question information was transmitted.

According to the invention, the artificial intelligence system has or implements a first artificial intelligence module and a second artificial intelligence module. The first artificial intelligence module is a part of or a target of a reading comprehension processing chain, i.e., a processing chain based on processing natural language by machine, and the second artificial intelligence module is a part of or a target of a search processing chain, i.e., a processing chain based on performing a search (or a search query) or a plurality of searches (or multiple such search queries). An artificial intelligence module which is used within the scope of the present invention is trained via corresponding training data.

According to the invention, it is provided that, after the question information to be handled has been fed to the reading comprehension processing chain and the search processing chain in a first step, in a second step, at least one item of paragraph information is generated by or in the search processing chain and is fed to the reading comprehension processing chain, i.e., according to the invention, largely parallel processing of the question information both in or by the reading comprehension processing chain and in or by the search processing chain initially takes place. However, this does not mean that the question information is processed in the same manner by the reading comprehension processing chain and by the search processing chain. Proceeding from the question information on the one hand and the paragraph information, which is generated by the search processing chain and is forwarded or sent to the reading comprehension processing chain, on the other hand, the reading comprehension processing chain or, in particular, the first artificial intelligence module is able to produce or generate answer candidate information (hereinafter also referred to as first answer candidate information) in a third step. In parallel thereto, (likewise in or during the third step) the search processing chain or, in particular, the second artificial intelligence module also generates or produces answer candidate information (hereinafter also referred to as second answer candidate information). The first answer candidate information comprises first score information and, correspondingly, the second answer candidate information also comprises second score information. Proceeding from these two items of answer candidate information of the two artificial intelligence modules, which information is produced in consideration of the question information to be handled or answered, it is provided according to the invention that, in a fourth step, an evaluation and/or decision is made via or in or by a validation confidence processing chain as to whether either the first (or a part of the first) answer candidate information or the second (or a part of the second) answer candidate information or neither of the two is or should be selected as the answer information to be given. If the first answer candidate information is selected, this answer (to the question information to be handled), which was automatically produced by a method according to the invention, is output to a user, in particular a person using the telecommunications terminal and in particular on (or by or at) the telecommunications terminal; if the second answer candidate information is selected, this applies to the second answer candidate information, whereas if none of the two items of answer candidate information is selected, information is output to the user (or to the telecommunications terminal) in order to convey that an answer to the question information to be handled is not possible or that the question to be handled cannot be answered.

According to the invention, it is provided, as already mentioned, that an open domain artificial intelligence system is used or implemented. Such an open domain Q&A system (question-and-answer service) is a system that is capable of finding answers to complex knowledge questions. Knowledge is defined as lexical knowledge, for example based on a large number of documents, such as device descriptions, device function descriptions or other functional descriptions or knowledge contents, for example also including articles or parts thereof or the total number of articles from Wikipedia (in each case in one language or in the language identified during acquisition of the question information). The term “open domain question-and-answer service” is used because a system or a method according to the invention is independent of a (single) (knowledge) domain or independent of a (specific) topic, i.e., independent of, for example, device manuals of a specific manufacturer of devices or of specific knowledge areas, such as the population or the geography. A system or a method according to the invention is furthermore independent of any question type; it is a question-and-answer system (question-and-answer service) so that it is, in particular, based on question-answer pairs. A system according to the invention or the method according to the present invention is, in particular, provided to cooperate or interact with other function blocks of an environment of various functionalities or devices or systems, such as the telecommunications terminal (or the client device, i.e., the terminal of a customer), a speech recognition functionality (automatic speech recognition, ASR), automatic wake word recognition (for example, a codeword “Hello Magenta,” “Technical question,” etc.), a speech-to-text component or functionality (STT), or a text-to-speech component or functionality (TTS). In particular, a system according to the invention or the method according to the present invention is provided to answer complex knowledge questions or to provide answers to complex knowledge questions.

According to a preferred embodiment of the present invention, the first artificial intelligence module and/or the reading comprehension processing chain is based on a machine learning model, in particular on the basis of or using one or a plurality of the following systems or system architectures for natural language processing (NLP):
QANet,
BERT (Bidirectional Encoder Representations from Transformers),
GPT-2 (Generative Pretrained Transformer 2),
GPT-3 (Generative Pretrained Transformer 3),
SQuAD (Stanford Question Answering Dataset),
wherein the at least one item of paragraph information is used to produce the first answer candidate information,
wherein, in particular, training data comprising question-and-answer pairs are fed to the first artificial intelligence module, in particular before the first step is carried out,
wherein, in particular, the question information is fed in its original form to the first artificial intelligence module.

By using such systems or system architectures for natural language processing, it is advantageously possible according to the invention to achieve a comparatively good performance of the overall system. The training data for the first artificial intelligence module are provided, in particular, in the form of question-and-answer pairs, but an artificial intelligence module which is used in the scope of the present invention is trained via corresponding training data.

According to another embodiment of the present invention, it is provided that the second artificial intelligence module and/or the search processing chain comprises a question analysis module, wherein structured question information is generated via the question analysis module from the question information to be handled, wherein the structured question information is subjected to a search on an open domain information dataset, in particular using an Elasticsearch search, wherein, in particular, at least one additional search is furthermore carried out, wherein, in particular, the second artificial intelligence module and/or the search processing chain is based on or comprises a machine learning model and, in particular, comprises a selection model and/or an answer extraction model, wherein a search operation and a selection operation are furthermore performed multiple times, in particular in order to produce the at least one item of paragraph information and/or to produce the second answer candidate information,
wherein, in particular, the selection-extraction model is used to produce the second answer candidate information,
wherein, in particular, at least one highlighting step takes place, in particular in conjunction with an Elasticsearch search.

In this way, it is advantageously possible according to the invention to achieve a more accurate search and thus also better search results.

According to another embodiment of the present invention, it is provided that the second artificial intelligence module and/or the search processing chain has an answer extraction functionality, wherein the answer extraction functionality selects one or a plurality of sentences from a selected paragraph of text, in particular on the basis of the paragraph information, and provides said sentence(s) as second answer candidate information or as a part thereof.

As a result, it is advantageously possible according to such embodiments of the invention to achieve good results as well as comparatively good performance of the overall system.

According to another embodiment of the present invention, it is provided that the validation confidence processing chain comprises an ensemble controller and a third artificial intelligence module, wherein a selection from the first and the second answer candidate information is made via the ensemble controller on the basis of the first and the second score information, and wherein a validation with regard to the confidence in a correct answer of the first answer candidate information and/or the second answer candidate information is carried out via the third artificial intelligence module,
wherein, in particular, the selection from the first and the second answer candidate information is carried out in a first sub-step of the fourth step, and only the selected answer candidate information is validated via the third artificial intelligence module in a second sub-step of the fourth step.

In this way, according to the present invention, it is easily possible to achieve good answer results in a particularly reliable manner.

According to another embodiment of the present invention, it is provided that the question-and-answer service, in addition to the artificial intelligence system, furthermore comprises an additional artificial intelligence system or has access to or uses such a system, wherein question information is likewise fed to the additional artificial intelligence system as an input variable and the additional artificial intelligence system likewise generates answer information as an output variable and/or provides this information, in particular to the telecommunications terminal, wherein the additional artificial intelligence system is a closed domain artificial intelligence system and comprises a natural language understanding module, wherein the method, in relation to the question information to be handled and in order to generate answer information to be given, furthermore comprises determining intent information in a fifth step taking place before the first step, wherein a decision is made depending on the intent information as to whether the question information is fed to the artificial intelligence system or to the additional artificial intelligence system in order to produce the answer information,
wherein, in particular, the additional artificial intelligence system is selected for producing the answer information, provided that the determined intent information has a value from a predetermined group of intent information values, while the artificial intelligence system is selected to produce the answer information, provided that the determined intent information has at least one other value or corresponds to a non-intent value.

In this way, it is advantageously possible according to the invention to achieve a more accurate search and thus also better search results. In particular, a system according to the invention or the method according to the present invention is provided to answer complex knowledge questions or to provide answers to complex knowledge questions; in particular, an additional artificial intelligence system is optionally provided for simple or simpler knowledge questions, wherein examples of simple knowledge questions are as follows: “What dimensions does ‘system X’ have?” (with an intent information value of, for example, “system_size/dimensions”); “How old is ‘person Y’?” (with an intent information value of, for example, “person_age”).

According to another embodiment of the present invention, it is provided that the question-and-answer service provided to the telecommunications terminal via the telecommunications network comprises a speech recognition functionality and/or a speaker recognition functionality and/or a wake word functionality and/or a speech-to-text functionality and/or a text-to-speech functionality in addition to the artificial intelligence system.

As a result, according to one embodiment of the invention, it is advantageously possible for the answer information to be output in a particularly simple and convenient manner on the telecommunications terminal or to be forwarded from the telecommunications terminal to a system according to the invention, in particular the question-and-answer service.

In a further exemplary embodiment, the invention provides a system for assisting the improved operation of a question-and-answer service provided to a telecommunications terminal via a telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain, and wherein the second artificial intelligence module is a part or a target of a search processing chain,
wherein the system, in relation to the question information to be handled and in order to generate answer information to be given, is configured such that:
   the question information to be handled is fed to the reading comprehension processing chain and to the search processing chain,
   at least one item of paragraph information is generated by or in the search processing chain and is fed to the reading comprehension processing chain,
   the first artificial intelligence module produces first answer candidate information based on the reading comprehension processing chain and the at least one item of paragraph information, and
   the second artificial intelligence module produces second answer candidate information based on the search processing chain, wherein the first answer candidate information comprises first score information, and wherein the second answer candidate information comprises second score information,
   an evaluation and/or decision is made via or in a validation confidence processing chain as to whether any of the following is selected or to be selected as answer information to be given
      the first answer candidate information or a part thereof or
      the second answer candidate information or a part thereof or
      neither of the two.

According to the present invention, it is thus advantageously possible to provide a system according to the invention that corresponds to a method according to the invention and thus to achieve improved operation of a question-and-answer service provided, in particular, via the telecommunications terminal connected to the telecommunications network.

In a further exemplary embodiment, the invention provides a telecommunications network for assisting the improved operation of a question-and-answer service provided via a telecommunications terminal connected to the telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain, and wherein the second artificial intelligence module is a part or a target of a search processing chain,
wherein the telecommunications network, in relation to the question information to be handled and in order to generate answer information to be given, is configured such that:
   the question information to be handled is fed to the reading comprehension processing chain and to the search processing chain,
   at least one item of paragraph information is generated by or in the search processing chain and is fed to the reading comprehension processing chain,
   the first artificial intelligence module produces first answer candidate information based on the reading comprehension processing chain and the at least one item of paragraph information, and
   the second artificial intelligence module produces second answer candidate information based on the search processing chain, wherein the first answer candidate information comprises first score information, and wherein the second answer candidate information comprises second score information,
   an evaluation and/or decision is made via or in a validation confidence processing chain as to whether any of the following is selected or to be selected as answer information to be given
      the first answer candidate information or a part thereof or
      the second answer candidate information or a part thereof or
      neither of the two.

According to the present invention, it is thus advantageously possible to provide a telecommunications network according to the invention that corresponds to a method according to the invention and thus to achieve improved operation of a question-and-answer service provided, in particular, via the telecommunications terminal connected to the telecommunications network.

Furthermore, the output is achieved by a question-and-answer service or a question-and-answer service system for provision to a telecommunications terminal via a telecommunications network, wherein the question-and-answer service comprises an artificial intelligence system or has access to or uses such a system, wherein question information is fed to the artificial intelligence system as an input variable and the artificial intelligence system generates answer information as an output variable and/or provides this information, in particular to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain and the second artificial intelligence module is a part or a target of a search processing chain,
wherein the question-and-answer service, in relation to the question information to be handled and in order to generate answer information to be given, is configured such that:
   the question information to be handled is fed to the reading comprehension processing chain and to the search processing chain,
   at least one item of paragraph information is generated by or in the search processing chain and is fed to the reading comprehension processing chain,
   the first artificial intelligence module produces first answer candidate information based on the reading comprehension processing chain and the at least one item of paragraph information, and
   the second artificial intelligence module produces second answer candidate information based on the search processing chain, wherein the first answer candidate information comprises first score information, and wherein the second answer candidate information comprises second score information,
   an evaluation and/or decision is made via or in a validation confidence processing chain as to whether any of the following is selected or to be selected as answer information to be given
      the first answer candidate information or a part thereof or
      the second answer candidate information or a part thereof or
      neither of the two.

According to the present invention, it is thus advantageously possible to provide a question-and-answer service according to the invention or a question-and-answer service system that corresponds to a method according to the invention and thus to achieve improved operation of a question-and-answer service provided, in particular, via the telecommunications terminal connected to the telecommunications network.

Furthermore, the output is achieved by a computer program comprising commands via which the steps of a method according to the invention can be carried out if the computer program is executed on a programmable device, in particular on a system according to the invention or a network node of the telecommunications network or a question-and-answer service or a question-and-answer service system.

In a further exemplary embodiment, the invention provides a computer-readable medium provided for storing a computer program, or a data carrier signal provided for transmitting a computer program, wherein the computer-readable medium or the data carrier signal stores or transmits the computer program, or wherein the computer-readable medium or the data carrier signal stores or transmits a part of the computer program that is to be executed on a programmable device, in particular on a network node of the telecommunications network and/or as part of a question-and-answer service.

Further details, features, and advantages of the invention emerge from the drawings, and from the following description of preferred embodiments with reference to the drawings. The drawings merely illustrate exemplary embodiments of the invention and are not limiting.

In the various figures, identical parts are provided with the same reference signs and are therefore generally also named or mentioned only once in each case.

The present invention is described with reference to example embodiments and with reference to example drawings, but the invention is not limited thereto and is only limited by the claims. The drawings described are merely schematic and non-limiting. In the drawings, the size of some elements may be exaggerated and not drawn to scale for illustrative purposes.

If an indefinite or a definite article is used when reference is made to a singular noun, e.g., “a,” “an,” “the,” this includes a plural of this noun, unless expressly indicated otherwise.

Furthermore, the terms “first,” “second,” “third,” and the like are used in the description and in the claims to distinguish between similar elements and not necessarily to describe a sequential or chronological order. It should be understood that the terms thus used are interchangeable under suitable circumstances and that the embodiments of the invention described herein may work in a different sequence to that described or illustrated herein.

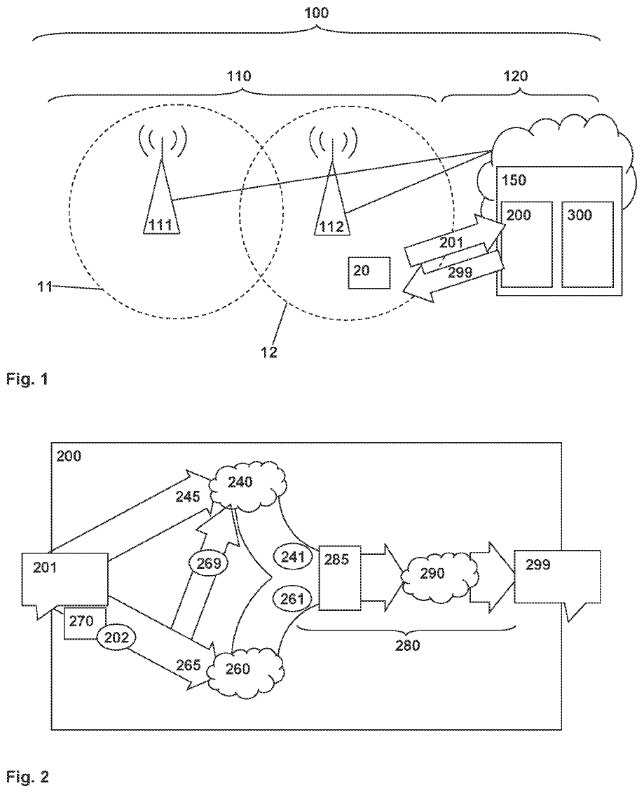

FIG. 1 schematically illustrates a telecommunications network 100 for assisting the improved operation to a telecommunications terminal 20 of a provided question-and-answer service 150 schematically communications network 100 according to the present invention. According to the exemplary embodiment of FIG. 1, the telecommunications network 100 is implemented as a mobile network comprising a radio access network 110 and a core network 120. The radio access network 110 of the telecommunications network 100 consists of a large number of radio cells, of which a first radio cell 11 and a second radio cell 12 are shown by way of example. The radio cells 11, 12 correspond to geographical radio coverage areas of base station units, typically NodeBs, eNodeBs, or gNodeBs, of which a first base station unit 111 and a second base station unit 112 are shown schematically in FIG. 1. The telecommunications network 100 is configured to provide communication services for a large number of telecommunications terminals, but only the telecommunications terminal 20 is shown. The question-and-answer service 150 comprises an artificial intelligence system 200 or has access to or uses such a system. Question information 201 is fed to the artificial intelligence system 200 as an input variable and the artificial intelligence system 200 generates or produces answer information 299 as an output variable, which is provided, in particular, to the telecommunications terminal 20.

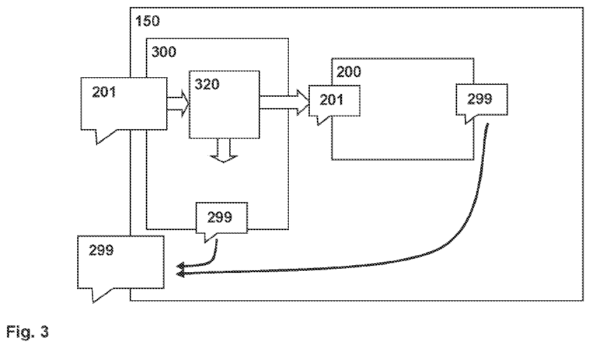

In this case, the artificial intelligence system 200 is provided or configured according to the invention as an open domain artificial intelligence system. According to the embodiment or design variant shown in FIG. 1, the question-and-answer service 150 comprises at least one additional artificial intelligence system 300 in addition to the artificial intelligence system 200. Such a configuration of the question-and-answer service 150 is also shown in FIG. 3, i.e., the question-and-answer service 150 according to the invention comprises the artificial intelligence system 200 and the additional artificial intelligence system 300. The additional artificial intelligence system 300 is provided or configured, in particular, as a closed domain artificial intelligence system. Question information 201 is likewise fed to the additional artificial intelligence system 300 as an input variable and the additional artificial intelligence system 300 likewise generates answer information 299 as an output variable (or provides this information to the telecommunications terminal 20). The additional artificial intelligence system 300 or the question-and-answer service 150 in particular comprises a natural language understanding module 320, via which a decision is made as to whether the question information 201 is forwarded to the artificial intelligence system 200 or to the additional artificial intelligence system 300 in order to produce the answer information 299.

According to the invention, as an alternative to the embodiment shown in FIG. 1 and FIG. 3, question-and-answer services 150 having only the artificial intelligence system 200 or an artificial intelligence system of the open domain type are also possible and preferred. Furthermore, it may also be alternatively provided that, in addition to the artificial intelligence system 200 and the additional artificial intelligence system 300, additional artificial intelligence systems (not shown in FIG. 1) are part of the question-and-answer service 150.
As a result, it is possible according to the invention for complex knowledge questions to be answered via a system or method according to the invention, in particular by the artificial intelligence system 200. At the same time, in particular simple knowledge questions, such as a question regarding a specific dimension or measurement of a device or questions regarding the age of a specific person, may be answered by another system, in particular the additional artificial intelligence system 300.

According to the invention, it is in particular provided to supply the question-and-answer service 150 and, in particular, the artificial intelligence system 200 with question information 201. Both the artificial intelligence system 200 and the additional artificial intelligence system 300 (if present) are concerned with answering a customer's knowledge-oriented questions: For this purpose, it is preferably provided according to the invention, in particular, that so-called intentions or intent information are defined and are trained with machine learning models in an NLU (natural language understanding) unit, which is in particular part of the question-and-answer service 150 or part of the artificial intelligence system 200. In particular, according to the invention, the artificial intelligence system 200 is linked to at least one such item of intent information (or to an intent information value) or the artificial intelligence system 200 is linked to a non-intent value being detected, determined, or assigned as intent information. In order to distribute or analyze question information 201, in particular a so-called NLU dispatcher is provided according to the invention: The NLU dispatcher is a machine learning model that is trained to determine which skill is to answer the question. For example, if the question “What is the weather currently like in a specific city?” is to be answered, it is recognized on the one hand as the value of the intent information that a weather-related question has been asked (i.e., the intent information value corresponds approximately to a “weather intent”) and triggers a corresponding capability (for example a “weather capability”). The NLU dispatcher is also trained with some open domain Q&A example questions that trigger the knowledge skill, i.e., activation of the artificial intelligence system 200. According to the invention, the question-and-answer service 150 and/or the artificial intelligence system 200 furthermore comprises an additional NLU dispatcher, which is also a machine learning model. This model is trained for the knowledge skill. It identifies which intent or which intent information value of the knowledge domain should be triggered in order to answer the question. Again, in order to activate the artificial intelligence system 200, it is necessary for the associated intent information value (which is associated with this artificial intelligence system 200) to be recognized, for example the intent “open domain Q&A” or the intent “non-intent.” If the artificial intelligence system 200 is activated, the associated processing chain is activated, which is described in more detail below in conjunction with FIG. 2.

FIG. 2 schematically illustrates an artificial intelligence system 200 according to the invention for a or as part of a question-and-answer service 150 of a telecommunications network 100 according to the invention. Again, the question information 201 is fed to the artificial intelligence system 200 as an input variable and the artificial intelligence system 200 generates or produces the answer information 299 as an output variable, which is subsequently provided in particular to the telecommunications terminal 20, which is however not shown in FIG. 2.

According to the invention, the artificial intelligence system 200 has or implements a first artificial intelligence module 240 and a second artificial intelligence module 260. The first artificial intelligence module 240 a part or a target of a reading comprehension processing chain 245 and the second artificial intelligence module 260 a part or a target of a search processing chain 265. Based on question information 201 that is specifically present, i.e., to be handled, at a specific time, i.e., in order to generate the answer information 299 to be given or associated with this question information 201, the following steps are carried out according to the invention:

In a first step, the question information 201 to be handled is fed to the reading comprehension processing chain 245 and to the search processing chain 265.

In a second step following the first step, at least one item of paragraph information 269 is generated by or in the search processing chain 265 and is fed to the reading comprehension processing chain 245. In a third step following the second step, the second artificial intelligence module 260 produces second answer candidate information 261 based on the search processing chain 265. In order to process the question information and, in particular, in order to generate the paragraph information 269 or the second answer candidate information 261 in the search processing chain 265, the search processing chain 265 (and/or the second artificial intelligence module 260) comprises a question analysis module 270 via which structured question information 202 is generated from the question information 201 to be handled. The structured question information 202 is then subjected to a search on an open domain information dataset or, via the structured question information 202, a search is performed on the open domain information dataset, in particular using an Elasticsearch search. In the process, in particular after a highlighting step is carried out, in particular in conjunction with a or the Elasticsearch search, document information is generated, in particular comprising a plurality of documents of the open domain information dataset. Furthermore, in particular at least one additional search is performed, in particular using an additional Elasticsearch search, in order to generate the paragraph information 269 in the search processing chain 265. In the process, in particular after an additional highlighting step is carried out, in particular in conjunction with a or the additional Elasticsearch search, the paragraph information 269 is generated, in particular comprising a plurality of paragraphs of one or a plurality of documents of the open domain information dataset. The paragraph information 269 is fed to the reading comprehension processing chain 245 and the second answer candidate information 261 is generated from the paragraph information 269 in or as part of the search processing chain 265. The second artificial intelligence module 260 and/or the search processing chain 265 is based, in particular, on or comprises a machine learning model, in particular in the form of a selection model and/or an answer extraction model, wherein, in particular, the answer extraction model is used to produce the second answer candidate information 261 proceeding from the paragraph information 269, and wherein, in particular, the selection model is used to produce the paragraph information 269.

In the third step, the first artificial intelligence module 240 furthermore also, i.e., in particular substantially in parallel to or at least partially at the same time as the search processing chain 265 or the second artificial intelligence module 260 produces the second answer candidate information 261, produces first answer candidate information 241 based on the reading comprehension processing chain 245 and the at least one item of paragraph information 269. In particular, the question information 201 is fed in its original form to the first artificial intelligence module 240. The first artificial intelligence module 240 and/or the reading comprehension processing chain 245 is based, in particular, on a machine learning model, in particular on the basis of or using one or a plurality of the following systems or system architectures for natural language processing, NLP: QANet, BERT (Bidirectional Encoder Representations from Transformers), GPT-2 (Generative Pretrained Transformer 2), GPT-3 (Generative Pretrained Transformer 3), SQuAD (Stanford Question Answering Dataset), wherein, in particular, training data comprising question-and-answer pairs are fed to the first artificial intelligence module 240 before the first step is carried out. In order to produce the first answer candidate information 241, both the question information 201 and the at least one item of paragraph information 269 are thus used.

In a fourth step following the third step, an evaluation and/or decision is made via or in a validation confidence processing chain 280 as to whether the or a part of the first answer candidate information 241 or the or a part of the second answer candidate information 261 or neither of the two is selected or to be selected as answer information 299 to be given.

According to the invention, score information is produced or assigned or allocated in each case to the first and the second answer candidate information 241, 261, in particular when said answer candidate information is produced by the first artificial intelligence system 240 or the second artificial intelligence system 260, which score information is used within the validation confidence processing chain 280 to evaluate and/or decide which answer candidate information is utilized or to be utilized for the answer information 299 to be given. In this case, the first answer candidate information 241 comprises the first score information and the second answer candidate information 261 comprises the second score information.

According to the invention, it is preferred that the validation confidence processing chain 280 has an ensemble controller 285 and a third artificial intelligence module 290, wherein a selection from the first and the second answer candidate information 241, 261 is made on the basis of the first and the second score information via the ensemble controller 285, and wherein a validation with respect to the confidence in a correct answer of the first answer candidate information 241 and/or the second answer candidate information 261 is carried out via the third artificial intelligence module 290, wherein, in particular, the selection from the first and the second answer candidate information 241, 261 is carried out in a first sub-step of the fourth step and only the selected answer candidate information is validated via the third artificial intelligence module 290 in a second sub-step of the fourth step.

According to the invention, it is in particular provided that the entire question of the user (i.e., the question information 201) is analyzed in the search processing chain 265 and, in particular, in the question analysis module 270. In the process, a linguistic analysis of the question takes place, for example question words are searched for; for example, a number is expected in the answer to a question word “how much.” Subsequently, the question or the question information 201 is converted into a search query, in particular via Elasticsearch, wherein Elasticsearch is a search engine on the basis of the program library Lucene, which stores documents in a NoSQL format. In the process, the document that most likely contains the answer to the question information 201 to be handled is searched for. According to the invention, in particular the highlighting function of Elasticsearch is used for this purpose; for example, the 10 best documents are highlighted and, in each case, provided with score values (i.e., the document information is generated, in particular comprising a plurality, for example 10, documents of the open domain information dataset). These score values indicate how likely it is that the document found contains the answer to be given. After the document information has been generated, i.e., after the documents (among the documents of the open domain information dataset) that, based on the model used, have the best score values for the answer to be given have been detected, the paragraph information (in particular among the paragraphs of the most promising documents found) is generated: In particular, the highlighting function of Elasticsearch is used again in order to find the top 10 paragraphs that most likely contain the answer to be given, for example from the top 10 documents. In the process, according to the invention, a machine learning model (selection model) is used to determine in an improved manner which paragraph has the best chance (i.e., which paragraph is assigned the highest score value (or best score value, based on the model used)) of containing the answer. This paragraph (or also this plurality of paragraphs (e.g., also the best 10 paragraphs) is (are) transferred as paragraph information 269 in the second step to the reading comprehension processing chain 245 or to the first artificial intelligence module 240.

The answer is extracted or the first or second answer candidate information is produced as follows: For example, in the first artificial intelligence module 240 or in the reading comprehension processing chain 245, QANet or Bert or another type of machine learning model is used to generate or produce an answer candidate (first answer candidate information 241) of the reading comprehension processing chain 245. In the second artificial intelligence module 260 or in the search processing chain 265, the most suitable sentences (of the paragraphs comprising the paragraph information 269) are identified from the generated paragraph information 269 and made available as (second) answer candidate information 261 of the search processing chain 265 (or the second artificial intelligence module 260). These found sentences could correspond to the answer information 299, i.e., these sentences could be made available as an answer, in particular to the telecommunications terminal 20. In particular, according to the invention, the answer is not reformulated; i.e., the sentences identified in the text are output as the best answer (i.e., in this case as second answer candidate information 261 and, if the second answer candidate information 261 was selected in the fourth step, as answer information 299 to be given).

According to the invention, the validation confidence processing chain 280 comprises an ensemble control system or an ensemble controller 285. The ensemble control system basically identifies which answer candidate (i.e., of the first and the second answer candidate information 241, 261) is most likely to be the one with the better answer, in particular based on the first and the second score information. The answer with the higher point score (i.e., the highest score information) has a higher probability of being the better answer.

According to the invention, the validation confidence processing chain 280 furthermore also comprises a third artificial intelligence module 290, via which the confidence in the selected answer or answer candidate information is evaluated: The selected answer or answer candidate information is validated as to whether it is true or false (based on the model used) in order to prevent incorrect answers as much as possible. The trust model is a machine learning model that is trained to recognize correct or incorrect answers. If the selected answer or answer candidate information is identified as an incorrect answer, neither of the two produced items of answer candidate information is selected as answer information 299, but rather a fallback answer is provided, for example of the type: “I'm sorry, I don't know.” Conversely, if the answer or the selected answer candidate information is correct (or is classified as correct based on the model used), it is made available or output as answer information 299, in particular on the telecommunications terminal 20 or to the telecommunications terminal 20.

For example, the following example situation (using the reading comprehension processing chain 245) applies as question information 201 and answer information 299:
Question information 201: “question”: “How do I dispose of the toner from a laser printer?”}, {“passage”: “The Waste Act prescribes environmentally friendly disposal. In addition, manufacturers are obliged to take back empty toner cartridges free of charge for disposal. For this purpose, they can be returned to the dealer or sent back to the manufacturer, for example. In addition, it is possible to refill toner cartridges with refill toner in order to avoid disposal entirely. Various companies have specialized in this work and purchase empty toner cartridges for prices ranging from 10 cents to 5 euros per piece and then sell them as rebuilt toner cartridges after filling them, replacing worn parts, and testing them. This is classified as ecologically and economically sensible since the toner cartridges are complex and consist of many different materials. Accordingly, a refilled cartridge usually costs significantly less than a new cartridge. Since 2012, it has also been possible to recycle defective toner cartridges in Germany. In the years before that, approximately 80% of the 55 million tons of cartridges produced were incinerated in Germany alone. During manufacture, a cartridge requires 2 kg of crude oil on average and produces approximately 6 kg of CO2. Toner cartridges must not be disposed of in the general waste bin. Even empty cartridges contain residues of toner and thus toxic substances that pose a danger to health and the environment, and they must therefore not be disposed of with household waste. Improper disposal also excludes recycling or even re-use.”
Answer information: {“answer”: “empty cartridges,” “score”: 0.15770404040813446, “sentence”: “\nEven empty cartridges contain residues of toner and thus toxic substances that pose a danger to health and the environment, and they must therefore not be disposed of with household waste.”}

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for operation of a question-and-answer service provided to a telecommunications terminal via a telecommunications network, wherein the question-and-answer service comprises, uses, or has access to an artificial intelligence system, wherein question information is fed to the artificial intelligence system as an input variable and the artificial intelligence system generates answer information as an output variable and/or provides the answer information to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain, and wherein the second artificial intelligence module is a part or a target of a search processing chain,
wherein the method comprises:
in a first step, question information to be handled is fed to the reading comprehension processing chain and to the search processing chain;
in a second step following the first step, at least one item of paragraph information is generated by or in the search processing chain and is fed to the reading comprehension processing chain;
in a third step following the second step, the first artificial intelligence module produces first answer candidate information based on the reading comprehension processing chain and the at least one item of paragraph information, and the second artificial intelligence module produces second answer candidate information based on the search processing chain, wherein the first answer candidate information comprises first score information, and wherein the second answer candidate information comprises second score information; and
in a fourth step following the third step, via or in a validation confidence processing chain, an evaluation and/or decision is made as to whether any of the following is selected or to be selected as answer information to be given:
the first answer candidate information or a part thereof; or
the second answer candidate information or a part thereof; or
neither of the two.

2: The method according to claim 1, wherein the first artificial intelligence module and/or the reading comprehension processing chain is based on a machine learning model, in particular on the basis of or using one or a plurality of the following systems or system architectures for natural language processing (NLP):
QANet,
BERT (Bidirectional Encoder Representations from Transformers),
GPT-2 (Generative Pretrained Transformer 2),
GPT-3 (Generative Pretrained Transformer 3), or
SQuAD (Stanford Question Answering Dataset);
wherein the at least one item of paragraph information is used to produce the first answer candidate information;
wherein training data comprising question-and-answer pairs are fed to the first artificial intelligence module before the first step is carried out;
wherein the question information is fed in its original form to the first artificial intelligence module.

3: The method according to claim 1, wherein the second artificial intelligence module and/or the search processing chain comprises a question analysis module, wherein structured question information is generated via the question analysis module from the question information to be handled, wherein the structured question information is subjected to a search on an open domain information dataset, in particular using an Elasticsearch search, wherein at least one additional search is furthermore carried out, wherein the second artificial intelligence module and/or the search processing chain is based on or comprises a machine learning model and, in particular, comprises a selection model and/or an answer extraction model, wherein a search operation and a selection operation are furthermore performed multiple times, in particular in order to produce the at least one item of paragraph information and/or to produce the second answer candidate information;
wherein the selection-extraction model is used to produce the second answer candidate information;
wherein at least one highlighting step takes place, in particular in conjunction with an Elasticsearch search.

4: The method according to claim 1, wherein the second artificial intelligence module and/or the search processing chain has an answer extraction functionality, wherein the answer extraction functionality selects one or a plurality of sentences from a selected paragraph of text, in particular on the basis of the paragraph information, and provides the selected sentence(s) as second answer candidate information or as a part thereof.

5: The method according to claim 1, wherein the validation confidence processing chain comprises an ensemble controller and a third artificial intelligence module, wherein a selection from the first and the second answer candidate information is made via the ensemble controller on the basis of the first and second score information, and wherein a validation with regard to the confidence in a correct answer of the first answer candidate information and/or the second answer candidate information is carried out via the third artificial intelligence module;
wherein the selection from the first and second answer candidate information is carried out in a first sub-step of the fourth step, and only the selected answer candidate information is validated via the third artificial intelligence module in a second sub-step of the fourth step.

6: The method according to claim 1, wherein the question-and-answer service furthermore comprises, uses, or has access to an additional artificial intelligence system, wherein question information is likewise fed to the additional artificial intelligence system as an input variable and the additional artificial intelligence system likewise generates answer information as an output variable and/or provides this information, in particular to the telecommunications terminal, wherein the additional artificial intelligence system is a closed domain artificial intelligence system and comprises a natural language understanding module, wherein the method, in relation to the question information to be handled and in order to generate answer information to be given, furthermore comprises determining intent information in a fifth step taking place before the first step, wherein a decision is made depending on the intent information as to whether the question information is forwarded to the artificial intelligence system or to the additional artificial intelligence system in order to produce the answer information;
wherein the additional artificial intelligence system is selectable for producing the answer information based on the determined intent information having a value from a predetermined group of intent information values, and the artificial intelligence system is selected to produce the answer information based on the determined intent information having at least one other value or corresponding to a non-intent value.

7: The method according to claim 1, wherein the question-and-answer service provided to the telecommunications terminal via the telecommunications network comprises a speech recognition functionality and/or a speaker recognition functionality and/or a wake word functionality and/or a speech-to-text functionality and/or a text-to-speech functionality in addition to the artificial intelligence system.

8.-12. (canceled)

13: One or more non-transitory computer-readable mediums having processor-executable instructions stored thereon for operation of a question-and-answer service provided to a telecommunications terminal via a telecommunications network, wherein the question-and-answer service comprises, uses, or has access to an artificial intelligence system, wherein question information is fed to the artificial intelligence system as an input variable and the artificial intelligence system generates answer information as an output variable and/or provides the answer information to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain, and wherein the second artificial intelligence module is a part or a target of a search processing chain,
wherein the processor-executable instructions, when executed, facilitate:
in a first step, question information to be handled is fed to the reading comprehension processing chain and to the search processing chain;
in a second step following the first step, at least one item of paragraph information is generated by or in the search processing chain and is fed to the reading comprehension processing chain;
in a third step following the second step, the first artificial intelligence module produces first answer candidate information based on the reading comprehension processing chain and the at least one item of paragraph information, and the second artificial intelligence module produces second answer candidate information based on the search processing chain, wherein the first answer candidate information comprises first score information, and wherein the second answer candidate information comprises second score information; and
in a fourth step following the third step, via or in a validation confidence processing chain, an evaluation and/or decision is made as to whether any of the following is selected or to be selected as answer information to be given:
the first answer candidate information or a part thereof; or
the second answer candidate information or a part thereof; or
neither of the two.

14: One or more devices for operation of a question-and-answer service provided to a telecommunications terminal via a telecommunications network, wherein the question-and-answer service comprises, uses, or has access to an artificial intelligence system, wherein question information is fed to the artificial intelligence system as an input variable and the artificial intelligence system generates answer information as an output variable and/or provides the answer information to the telecommunications terminal, wherein the artificial intelligence system is an open domain artificial intelligence system and has or implements a first artificial intelligence module and a second artificial intelligence module, wherein the first artificial intelligence module is a part or a target of a reading comprehension processing chain, and wherein the second artificial intelligence module is a part or a target of a search processing chain,
wherein the one or more devices comprise:
one or more memories having executable instructions stored thereon; and
one or more processors configured to execute the instructions to facilitate the following being performed by the one or more devices:
in a first step, question information to be handled is fed to the reading comprehension processing chain and to the search processing chain;
in a second step following the first step, at least one item of paragraph information is generated by or in the search processing chain and is fed to the reading comprehension processing chain;
in a third step following the second step, the first artificial intelligence module produces first answer candidate information based on the reading comprehension processing chain and the at least one item of paragraph information, and the second artificial intelligence module produces second answer candidate information based on the search processing chain, wherein the first answer candidate information comprises first score information, and wherein the second answer candidate information comprises second score information; and
in a fourth step following the third step, via or in a validation confidence processing chain, an evaluation and/or decision is made as to whether any of the following is selected or to be selected as answer information to be given:
the first answer candidate information or a part thereof; or
the second answer candidate information or a part thereof; or
neither of the two.
